(19) United States
(12) Patent Application Publication
(10) Pub. No.: US 2008/0207265 A1
(43) Pub. Date: Aug. 28, 2008

(54) Wireless microphone based communications system

(75) Inventor: Ming-Cheng Chung, Taichung (TW)

Correspondence Address: BACON & THOMAS, PLLC, 625 SLATERS LANE, FOURTH FLOOR, ALEXANDRIA, VA, 22314, US

(73) Assignee: JTS PROFESSIONAL CO., LTD., Taichung (TW)

(21) Appl. No.: 11/709,833

(22) Filed: Feb. 23, 2007

(51) Int. Cl. H04B 1/38

(52) U.S. Cl. 455/557

(57) ABSTRACT

A communications system includes wireless microphones including a controller, a codec, a communications module, and an antenna; a wireless transceiver including a controller for setting an operating frequency and an ID thereof and an operating frequency and an ID of each microphone, a codec, a communications module, and an antenna; and a PC including a communications module and an antenna. In one operation performed between the transceiver and the microphone in which in the transceiver data is encoded with an ID, the encoded data is sent to the communications module, the communications module sends the data to the antenna, and the antenna sends radio waves containing the data, and in the microphone the antenna receives and sends the data to the communications module, the communications module sends the data to the codec for decoding, and the decoded data is sent to the controller for verification.

### BACKGROUND OF THE INVENTION

1. Field of Invention

The invention relates to wireless communications system and more particularly to such a system comprising a personal computer (PC), one or more wireless transceivers, and one or more wireless microphones in which data can be transferred between the PC and the microphone, between the PC and the transceiver, between the transceivers, or between the transceiver and the microphone wirelessly.

2. Description of Related Art

Conventionally, electrical devices including microphones and stereos are connected to wall outlets in a room of a KTV center. One drawback is that wires may get tangled.

Still conventionally, as an improvement of the above arrangement, the microphones are replaced with wireless ones. Also, one or more controllers are provided in which each controller is adapted to control two wireless microphones. Thus, for example, three controllers are required to for controlling six wireless microphones. This inevitably will increase operating cost greatly. Thus, the need for improvement still exists.

### SUMMARY OF THE INVENTION

It is therefore one object of the invention to provide a system comprising a PC, one or more wireless transceivers, and one or more wireless microphones in which data can be transferred between the PC and the microphone, between the PC and the transceiver, between the transceivers, or between the transceiver and the microphone wirelessly.

The above and other objects, features and advantages of the invention will become apparent from the following detailed description taken with the accompanying drawings.

### BRIEF DESCRIPTION OF THE DRAWINGS

FIG. 1 is a block diagram of a preferred embodiment of communications system according to the invention; and

FIG. 2 schematically depicts wireless connections of the components shown in FIG. 1.

### DETAILED DESCRIPTION OF THE INVENTION

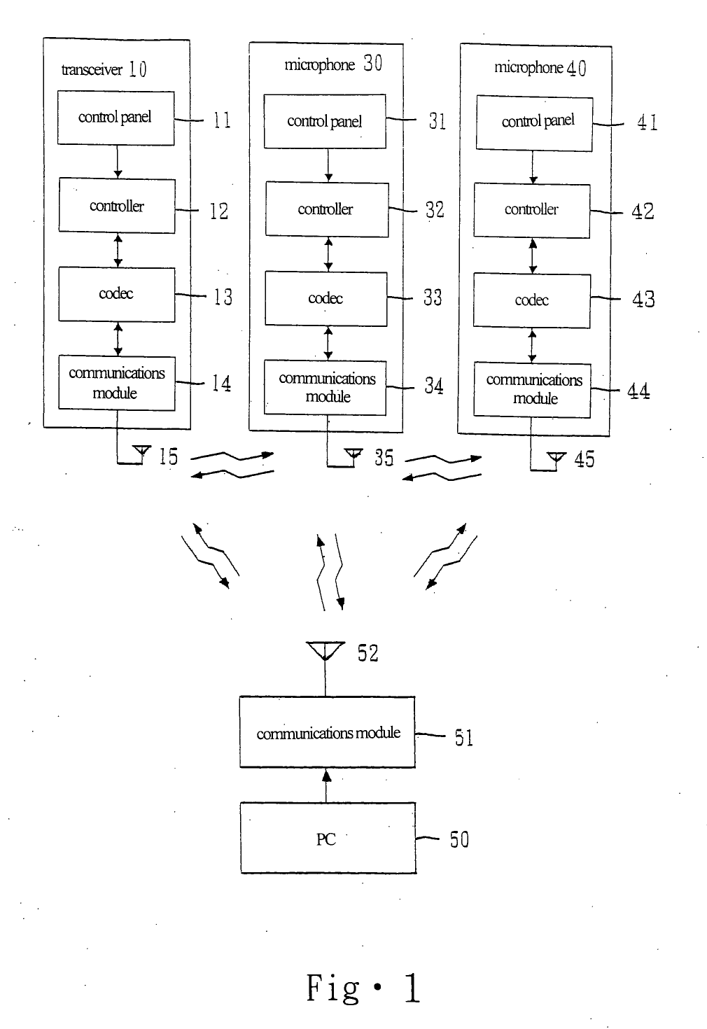

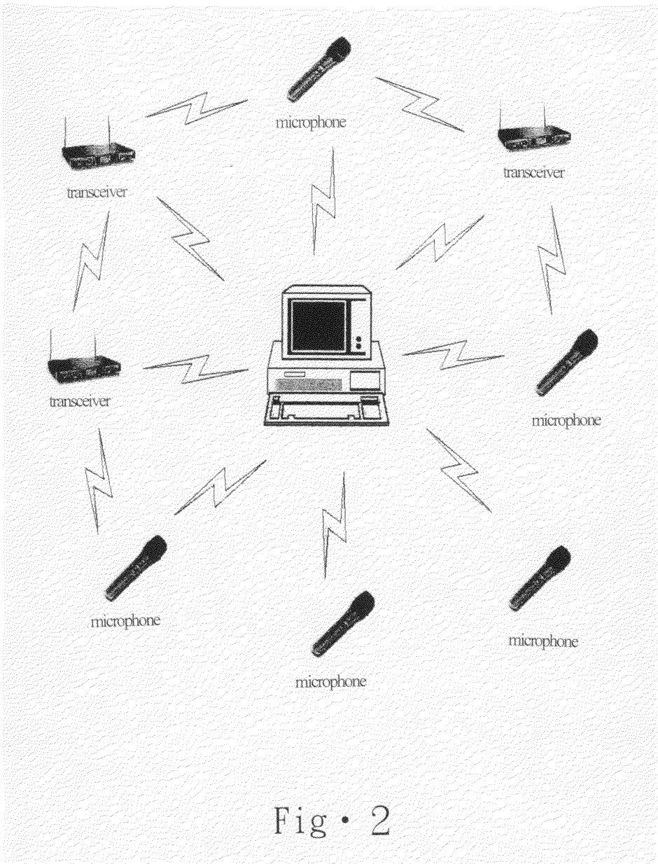

Referring to FIGS. 1 and 2, a communications system in accordance with a preferred embodiment of the invention is illustrated. The system comprises a wireless transceiver 10, a plurality of wireless microphones (two are shown for description purpose) 30, and a PC 50. Each component is discussed in detailed below.

The PC 50 has a communications module 51 and an antenna 52. The microphone 30 comprises a control panel 31; a controller 32 on the control panel 31 for setting a channel, transmission power, and a transmission range; a codec (coder-decoder) 33 in the control panel 31; a communications module 34 in the control panel 31; and an antenna 35 extending out of the housing of the wireless transceiver 30. Likewise, the microphone 40 comprises a control panel 41; a controller 42 on the control panel 41 for setting a channel, transmission power, and a transmission range; a codec (coder-decoder) 43 in the control panel 41; a communications module 44 in the control panel 41; and an antenna 45 extending out of the housing of the wireless transceiver 40.

The transceiver 10 comprises a control panel 11; a controller 12 on the control panel 11 for setting an operating frequency, an identification (ID), a channel, transmission power, and a transmission range and an operating frequency and an ID of each of the microphones (30, 40); a codec (coder-decoder) 13 in the control panel 11; a communications module 14 in the control panel 11; and an antenna 15 extending out of the housing of the transceiver 10.

For example, in an exemplary operation, data is first encoded with an ID by the codec 13 in which the ID is set by the controller 12. Next, the encoded data is sent to the communications module 14. Next, the communications module 14 sends the data to the antenna 15 which in turn sends radio waves containing the data to the antenna 35 for receiving. The received data is sent to the communications module 34 by the antenna 35. The communications module 34 in turn sends same to the codec 33 for decoding. Next, the decoded data is sent to the controller 32 for processing. In detail, the controller 32 determines whether ID of the received data to be valid or not by comparing the ID of the received data with an ID of the controller 32 in which the ID of the controller 32 is also set by the transceiver 10. The controller 32 then processes the received data accordingly if the comparison result is true.

It is noted that a single transceiver 10 can control a plurality of microphones (30, 40). Thus, operating cost is great reduced. Moreover, heat generated by the wireless transceiver 10 can be effectively dissipated.

It is possible of setting operating frequency of each of the microphones (30, 40). Moreover, it is possible of running software to operate the communications module 51 for sending data stored in the PC 50 to each of the microphones (30, 40) via the antenna 52. For example, the antenna 35 can receive the encoded data. The received data is sent to the communications module 34 which in turn sends same to the codec 33 for decoding. Next, the decoded data is sent to the controller 32 for processing (e.g., operating frequency setting) as instructed by the data. This can prevent two microphones from operating in the same operating frequency. Otherwise, interference can occur.

In addition, a user can operate either the controller 12 of the transceiver 10 or the PC 50 to remotely locate and eliminate the source of trouble occurred in any microphone. Further, either the controller 12 of the transceiver 10 or the PC 50 can reset the operating frequencies of the microphones (30, 40) for maintaining quality of the microphones.

Additionally, a two-way communication between the PC 50 and the transceiver 10, between the PC 50 and the microphone 30, between the transceiver 10 and the microphone 30, or between two transceivers 10 is possible.

While the invention herein disclosed has been described by means of specific embodiments, numerous modifications and variations could be made thereto by those skilled in the art without departing from the scope and spirit of the invention set forth in the claims.

What is claimed is:

1. A communications system comprising:
a plurality of wireless microphones each including a first control panel, a first controller on the first control panel, a first codec (coder-decoder) in the first control panel, a first communications module in the first control panel, and a first antenna;
a wireless transceiver including a second control panel, a second controller on the second control panel for setting an operating frequency and an ID (identification) thereof and an operating frequency and an ID of each microphone, a second codec in the second control panel, a second communications module in the second control panel, and a second antenna; and
a personal computer (PC) including a third communications module and a third antenna;
wherein in a first communications operation performed between the transceiver and one of the microphones in the transceiver data is encoded with an ID by the second codec, the encoded data is sent to the second communications module, the second communications module sends the encoded data to the second antenna, and the second antenna sends radio waves containing the encoded data, in the microphone the first antenna receives and sends the encoded data to the first communications module, the first communications module sends the encoded data to the first codec for decoding, and the decoded data is sent to the first controller, and the first controller is adapted to determine whether the ID of the decoded data is valid or not by comparing the ID of the decoded data with an ID of the microphone;
wherein in a second communications operation performed between the PC and one of the microphones in the PC data is encoded with an ID, the encoded data is sent to the third communications module, the third communications module sends the encoded data to the third antenna, and the third antenna sends radio waves containing the encoded data, in the microphone the first antenna receives and sends the encoded data to the first communications module, the first communications module sends the encoded data to the first codec for decoding, and the decoded data is sent to the first controller, and the first controller is adapted to determine whether the ID of the decoded data is valid or not by comparing the ID of the decoded data with an ID of the PC; and
wherein in a third communications operation performed between the PC and the transceiver in the PC data is encoded with an ID, the encoded data is sent to the third communications module, the third communications module sends the encoded data to the third antenna, and the third antenna sends radio waves containing the encoded data, in the transceiver the second antenna receives and sends the encoded data to the second communications module, the second communications module sends the encoded data to the second codec for decoding, and the decoded data is sent to the second controller, and the second controller is adapted to determine whether the ID of the decoded data is valid or not by comparing the ID of the decoded data with an ID of the PC.

2. The communications system of claim 1, further comprising a plurality of wireless second microphones and a wireless second transceiver.
